(19) United States
(12) Patent Application Publication
(10) Pub. No.: US 2002/0149934 A1
(43) Pub. Date: Oct. 17, 2002

(54) Structurally improved hose lamp

(76) Inventor: Mei-Lu Lin, Feng-Yuan City (TW)

Correspondence Address: Mei-Lu Lin, P.O. Box 697, Feng-Yuan City, 420, TW

(21) Appl. No.: 09/836,893

(22) Filed: Apr. 16, 2001

(51) Int. Cl. F21V 11/00

(52) U.S. Cl. 362/240; 362/250; 362/252; 362/373

(57) ABSTRACT

A structurally improved hose lamp includes an outer transparent hose having a of plurality longitudinal groove and splines spacedly formed on outer periphery, a plurality of thru holes in each of the splines with one of them inserted with copper wire and a pair of longitudinal protrusions on inner periphery, an inner transparent hose disposed into the outer transparent hose having a plurality of transverse tubes connected to a central bore for disposing a string of the Christmas light on one by one basis, a pair of electrical wires respectively connected with a pair of tips of the lights and a pair of longitudinal grooves in outer periphery made engageable with the longitudinal protrusions of the outer transparent hoes.

### BACKGROUND OF THE INVENTION

The present invention relates to hose lamp and more particularly to a structurally improved hose lamp which merits on dissipating of heat and diaphaneity.

Typical hose lamp comprises an outer hose and an inner hose, a string of Christmas lights disposed inside the inner hose. It is welcome by the users because of its good in waterproof and heat insulation. However, it is poor in heat dissipation and transparence.

### SUMMARY OF THE PRESENT INVENTION

The present invention has a main object to provide a structurally improved hose lamp which can effectively dissipate the heat, increase the transparence and the refraction and bend into different shapes of patterns.

Accordingly the hose lamp of the present invention comprises a transparent outer hose and a transparent inner hose disposed into the transparent outer hose. The transparent inner hose has a pair of conduct wires and a string of Christmas light having a pair of lead-in wire respectively connected with the conduct wires. The outer transparent hose has a plurality of longitudinal grooves spacedly formed on outer periphery to make a plurality of longitudinal splines therebetween. Each of the splines has a plurality of longitudinal thru holes one of which inserts with a copper wire. So that the hose lamp will be more transparent and merits on heat dissipation and is flexible.

The present invention will become more fully understood by reference to the following detailed description thereof when read in conjunction with the attached drawings.

### BRIEF DESCRIPTION OF THE DRAWINGS

FIG. 1 is an exploded perspective view to show a first preferred embodiment of the present invention,

FIG. 2 is a sectional view to show the assembly of FIG. FIG. 3 is an exploded perspective view to show a second preferred embodiment of the present invention, and

FIG. 4 is a sectional view to show the assembly of FIG. 3.

### DETAILED DESCRIPTION OF THE PREFERRED EMBODIMENT

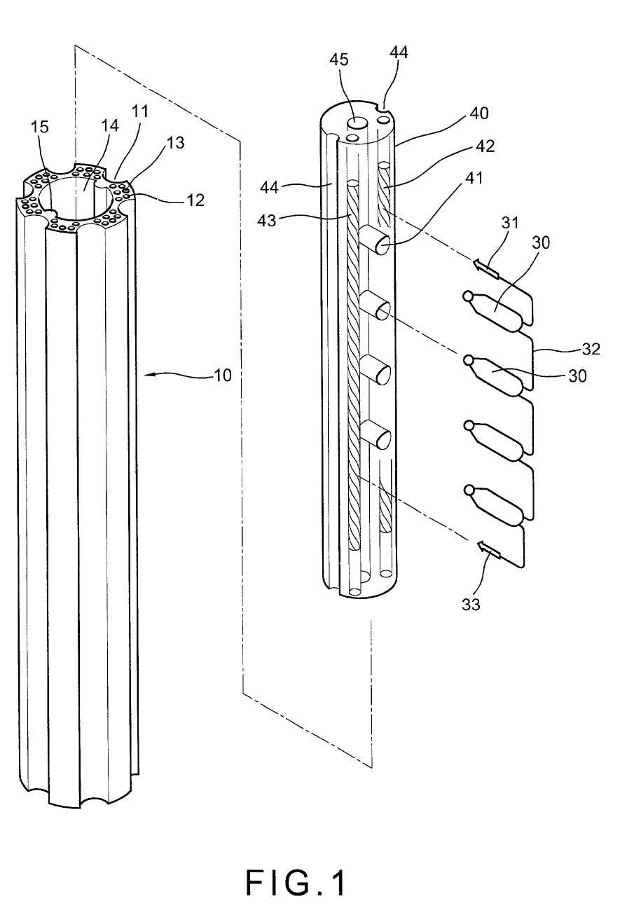

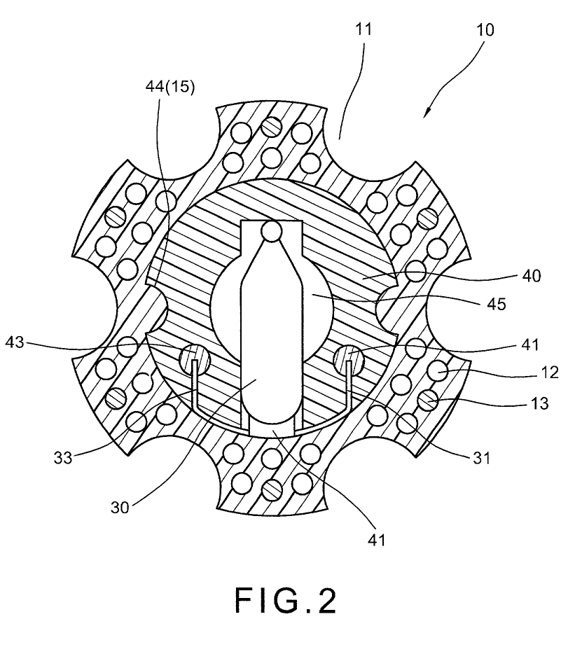

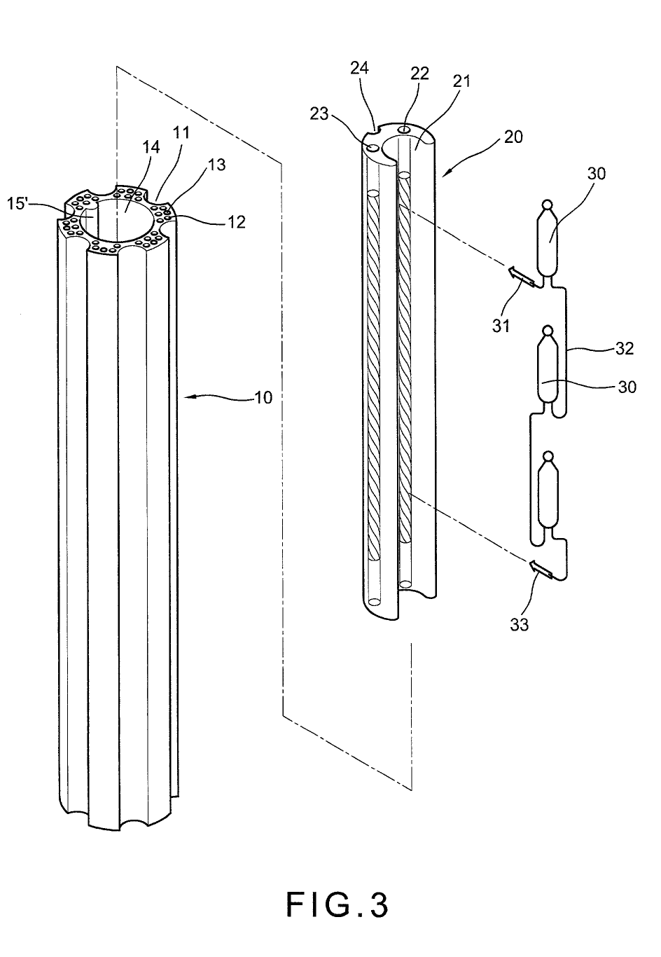

With reference to FIGS. 1 and 2 of the drawings, the hose lamp of the first preferred embodiment of the present invention comprises generally a transparent outer hose 10, a transparent inner hose 40 longitudinally disposed into the transparent outer hose 10 and a string of Christmas lights 30.

The outer transparent hose 10 has a plurality of longitudinal grooves 11 spacedly formed in outer periphery to make a plurality of longitudinal splines 12 therebetween, each having a plurality of longitudinal thru holes 13 one of which is inserted with a copper wire and a pair of longitudinal protrusions 15 respectively formed on opposing inner peripheries thereof.

The inner transparent hose 40 has a plurality of transverse tubes 41 spacedly connected to a central bore 45, a pair of conduct wires 42 and 43 longitudinally and spacedly disposed in the hose 40 on two sides of the tubes 41 and a pair of longitudinal grooves 44 respectively formed in the opposing outer peripheries engageable with the longitudinal protrusions 15 of the outer transparent hose 10.

The Christmas lights 30 are connected by lead-in wire 32 and has a first tip 31 on upper end and a second tip 33 on lower end.

When assembling, dispose the Christmas light 30 one by one into the transverse tubes 41, pierce the first tip 31 into the electrical wire 42 and the second tip 33 into the electrical wire 43 of the inner transparent hose 40. Then dispose the assembled inner transparent hose 40 into the space 14 of the outer transparent hose 10 to have the longitudinal grooves 44 engaged with the longitudinal grooves 44 engaged with the longitudinal protrusions 15. So that the inner transparent hose 40 will not be twisted or disengaged.

The above arrangement provides the following advantages:

a) the longitudinal grooves 11 as well as the longitudinal splines make the out transparent hose more bright and good for heat dissipation, especially provide multi-angle refraction of the light source,

b) avoids twist between the inner and outer transparent hoses,

c) saves material,

d) the transverse tubes 41 individually receive the heat from the light and the central bore 45 is helpful to the heat dissipation, and

e) the copper wires make the outer transparent hose 10 flexible to form different shapes of patterns.

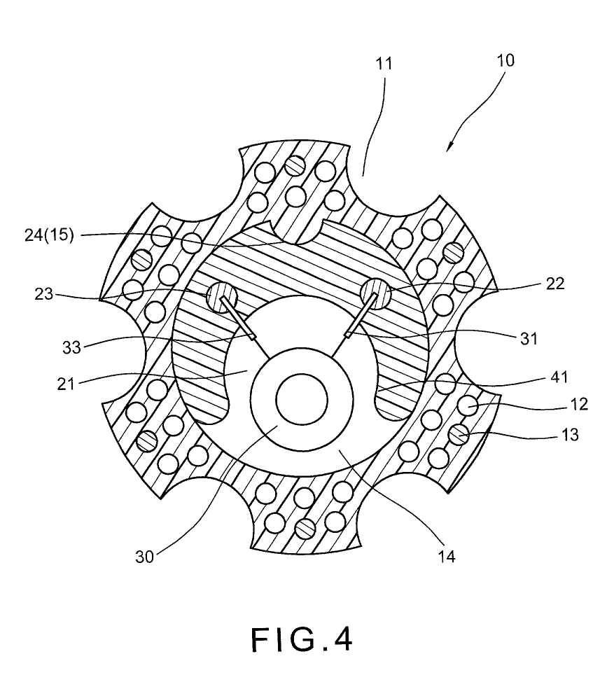

Referring to FIGS. 3 and 4, a second preferred embodiment is provided. In this embodiment, the outer transparent hose 10 is generally no different from that in the first preferred embodiment and the above discussions are applicable in the most instance. The only change is that the two longitudinal protrusions 15 now become a single longitudinal protrusion 15′. The inner transparent hose 40 becomes a new inner transparent hose 20 which has a body 21 of roughly U-shaped section, a pair of electrical wires 22 and 23 longitudinally and spacedly disposed in the body 21 and a single longitudinal groove 24 in an outer periphery. A string of Christmas lights 30 is structurally similar to that in the first preferred embodiment. The only different is that they a longitudinally disposed into the inner transparent hose 20 with the first tip 31 pierced into the wire 22 and the second tip 33 into the wire 23. When the inner transparent hose 20 disposes into the outer transparent hose 10. The function is no different from the hose lamp in the first preferred embodiment.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A structurally improved hose lamp comprising:
an out transparent hose having a plurality of longitudinal grooves spacedly formed in outer periphery to make a plurality of longitudinal splines therebetween each of the splines having a plurality of thru holes with one of which is inserted a copper wire and a pair of longitudinal protrusions respectively formed on opposing inner peripheries thereof;
an inner transparent hose disposed into the outer transparent hose having a plurality of transverse tubes spavedly connected to a central bore of the hose, a pair of first and second conduct wires longitudinally and spacedly disposed within the hose on two sides of the transverse tubes and a pair of longitudinal grooves respectively formed in opposing outer peripheries made engageable with the longitudinal protrusions of the outer transparent hose;
a string of Christmas light disposed into the inner transparent hose with the lights inserted one by one into the transverse tubes, a first tip pierced into the first electrical wire and a second tip pierced into the second electrical wire.

2. A structurally improved hose lamp comprising:
an outer transparent hose having a plurality of longitudinal grooves spavedly formed in outer periphery to make a plurality of longitudinal splines therebetween each of the splines having a plurality of thru holes with one of which is inserted a copper wire and a single longitudinal protrusion for in an inner periphery thereof;
an inner transparent hose disposed into the outer transparent hose, having a body of U-shaped section, a pair of first and second electrical wires longitudinally and spacedly disposed in the body and a single longitudinal groove in an outer periphery made engageable with the longitudinal protrusion of the outer transparent hose;
a string of Christmas lights longitudinally disposed into the inner transparent hose having a first tip pierced into the first electrical wire and a second tip pierced into the second electrical wire of the inner transparent hose.
